(19) United States
(12) Patent Application Publication
(10) Pub. No.: US 2026/0222475 A1
(43) Pub. Date: Jul. 30, 2026

(54) NETWORK DATA COMPRESSION WITH MULTI-MODAL AGENTIC FOUNDATION MODEL

(71) Applicant: Dell Products L.P., Round Rock, TX (US)

(72) Inventors: Gwenael Poitau, Montreal (CA); Ibrahim Abu Alhaol, Nepean (CA); Javad Mirzaei, Toronto (CA); Rohit Arora, San Jose, CA (US); Said Tabet, Austin, TX (US)

(21) Appl. No.: 19/039,123

(22) Filed: Jan. 28, 2025

(51) Int. Cl. H04L 67/60; G06N 5/02; H04L 43/55

(52) U.S. Cl. CPC H04L 67/60; H04L 43/55; G06N 5/02

(57) ABSTRACT

Network data management that includes data compression is disclosed. Multi-modal data from a network is collected and synchronized. A multi-modal model is trained to select data, in response to a prompt from a task model, based on the request, the multi-modal data, and/or data retrieved from a knowledge graph of the network. The selected multi-modal data is compressed and/or cleaned by the multi-modal model and returned to the task model. The task model is configured to perform operations or requests from applications of a radio intelligent controller associated with a network.

### TECHNOLOGICAL FIELD OF THE DISCLOSURE

Embodiments disclosed herein generally relate to data management systems and operations. More particularly, at least some embodiments relate to systems, hardware, software, computer-readable media, and methods for data management in digital twins of networks, including digital twins of radio access networks.

### BACKGROUND

A digital twin may be a computerized or virtual representation of a physical object or of physical systems. For example, a network, such as an open radio access network (O-RAN) can be modelled as a digital twin. A digital twin may also be used for testing, simulation, emulation, or other purposes. A network digital twin (NDT) may digitally implement the various components/applications/hardware/protocols of the physical network. The NDT is configured to receive data from the network such that the network can be tested, simulated, or emulated.

Conventional NDTs typically rely on a single form of data measurement from the network. More specifically, these NDTs rely on radio frequency (RF) related measurements and key performance indicators such as timestamps, velocity, direction, and signal strength.

However, these measurements or values are typically siloed and managed separately. Stated differently, conventional NDTs are unable to take into account the inter-dependencies that exist among components and applications operating in the network.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a digital twin configured with a model for performing data management, which may include data selection operations and data compression operations;

FIG. 2 discloses aspects of a radio access network associated with a radio intelligent controller and a digital twin;

FIG. 3 discloses additional aspects of a digital twin configured to perform model-based data management;

FIG. 4 discloses aspects of a method for performing data management in a network; and

FIG. 5 discloses aspects of a computing device, system, or entity.

### DETAILED DESCRIPTION OF SOME EXAMPLE EMBODIMENTS

Embodiments disclosed herein generally relate to data management in networks including radio access networks (RANs) or open radio access networks (O-RANs). More particularly, at least some embodiments relate to systems, hardware, software, computer-readable media, and methods for digital twin based data management, which may include model-based data selection and/or data compression operations.

Embodiments of the invention are discussed in the context of O-RANs, but are applicable to other networks, including wireless networks, telecommunication networks, and other radio networks.

Digital twins are digital or virtual representations of physical systems and NDTs may be used to represent O-RANs. In an O-RAN architecture or system, a radio intelligent controller (RIC) may perform or manage various operations and tasks with various types of applications that may include rApps (non-real-time-applications), dApps (domain-specific applications) and xApps (near-real-time applications).

Generally, rApps, which are typically located in a non-real time radio intelligent controller, may perform various operations or tasks such as managing policy, optimizing performance, and general network orchestration. Examples of rApps may include congestion forecasting, resource/power management, slicing operations, or the like. dApps are often employed in specific domains such as local or private networks, IoT (Internet of Things) operations, and the like. dApps may handle real-time demands that are sensitive to delay or latency. xApps may operate with higher proximity to the network and are configured to tasks or operations that include low-latency operations such as traffic steering, handover operations, or the like.

NDTs rely on measurements or representations of radio frequency (RF) signals and key performance indicators (KPIs). KPIs can be categorized into various types including network KPIs (e.g., latency, throughput, connection density), quality of service KPIs (e.g., handover success rate, jitter, network availability), operational KPIs (e.g., resource efficiency/usage, interoperability, fault recovery), AI/ML (artificial intelligence/machine learning) metrics (e.g., accuracy, inference time). These KPIs may include other key performance indicators such as time stamps, velocity (e.g., user equipment speed, direction), signal strengths, latency, throughput, and the like.

Processing RF signals/data and KPI data can require significant processing overhead. Because this type of data is often siloed, the dependencies are not captured in conventional RICs and digital twins. This may adversely impact the efficacy of applications such as dApps, rApps and xApps. In some example, fusion techniques are employed to capture some of these dependencies. However, fusion techniques are very complex and have a high processing overhead. Further, fusion techniques are often manual, task-specific, and unable to coordinate.

As a network grows and becomes heterogeneous, the measurement of conventional RF signals and KPIs may be unable to effectively meet the demands of RIC applications. In fact, these characteristics are associated with delays in the operations performed in conventional network digital twins (NDTs).

Embodiments of the invention relate to a radio intelligent controller (RIC) that is associated with or includes a digital twin configured to perform operations that rely on multi-modal data, which may include RF data and KPIs, and/or interdependencies that may exist in the network. Embodiments of the invention advantageously reduce delays, account for interdependencies in the network, and are better configured to meet the demand of RIC applications compared to conventional approaches.

In some examples, embodiments of the invention capture, in addition to RF signal or RF related data, data modalities that may include, but are not limited to, sensor data, camera data (e.g., RGB data, depth images), two or three dimensional LiDAR (light detection and ranging) data, and the like. Embodiments of the invention further relate to a model (e.g., a large language model (LLM) or an agentic foundation model (AFM)) configured to select, clean, and/or compress, multiple data modalities. Selecting data may refer, by way of example, to selecting data that is likely to be more relevant to a particular task. Cleaning the data may include, by way of example, removing redundancy, handling missing values, performing normalization operations, and the like.

The selection and processing of multiple data modalities may depend on the requests from other models that are configured to perform operations or tasks for RIC applications (e.g., rApps, xApps, dApps). In one example, the self-attention mechanism of models such as AFMs allows inter-dependencies among network components/hardware/applications to be captured during training and reflected in output after being deployed. Advantageously, data can be selected, compressed, and/or cleaned efficiently while respecting the inter-relations or inter-dependencies of the network. In some examples, a knowledge graph of the network may enhance or the selection of data responsive to a request, cleaning the selected data, and/or compressing the selected data.

Embodiments of the invention relate to an NDT that ingests multi-modal data. This advantageously provides an improved understanding and modeling of a physical environment and provides additional data that results in a more accurate state of the network. Models, such as AFMs are configured to select data that is responsive to a request, clean the data and/or compress the data. Compressing multi-modal data using AFMs in a model trained on historical network data helps ensure that the inter-dependencies that exist in the network are captured by the model. This helps make the NDT more robust to noise and incomplete data measurements.

In some examples, the NDT may be implemented in a distributed manner. For example, models may be distributed to edge locations to help optimize data movement, data storage, and compute requirements. Further, embodiments of the invention enable semantic information exchange in RICs and/or NDTs.

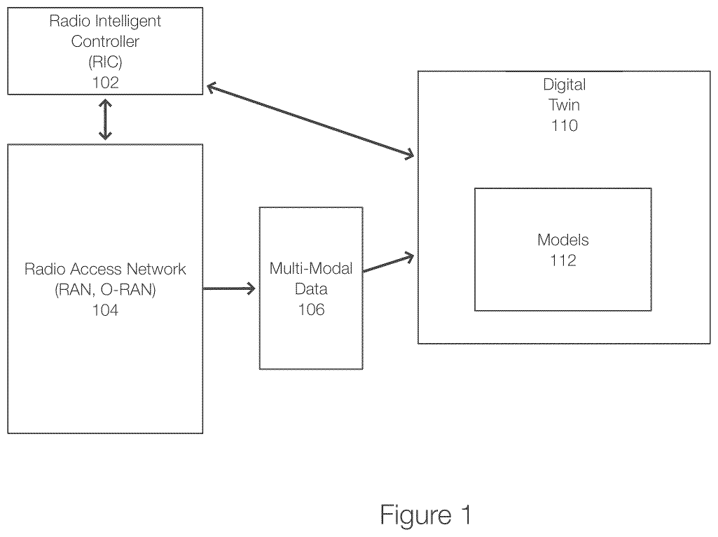

FIG. 1 discloses aspects of a digital twin configured with models for performing data management, which may include data selection operations, data cleaning operations, and/or data compression operations. More specifically, FIG. 1 illustrates a network 104, which is representative of networks including, but not limited to O-RANs, telecommunication networks, or the like. The network 104 is associated with an RIC 102. The RIC 102 is generally configured to control or manage the operation of the network 104. This may include, by way of example only, optimizing network performance, performing traffic control/steering, handover operations, power level control operations, or the like.

In this example, the network 104 is modeled by, represented by, and/or associated with a digital twin 110. The digital twin 110 may receive multi-modal data 106 from the network 104. Examples of multi-modal data 106 may include, but are not limited to camera data (RGB data, depth data), LiDAR data, RF data, position (e.g., GPS or global positioning system) data, KPIs, sensor data, or the like or combinations thereof. The multi-modal data 106 is input to the digital twin 110 and may be accessible to the models 112.

The models 112 may include task specific models and an AFM (or other model). The RIC 102 (or specific applications) may send commands/requests to the task specific models that may require network data. The task specific models may prompt the AFM and the AFM selects, cleans, and/or compresses data that is responsive to the request. The output of the AFM, which includes the compressed data, is delivered to the requesting task model. The task model may decompress the compressed data as needed. This improves the operation and efficiency of the task models at least because the data included in the output is responsive to the request and the task model is relieved of the need to evaluate all of the network data.

For example, the RIC 102 may perform traffic steering (due to network congestion), which may include dynamically routing network traffic. The RIC 102 may request a task model to identify towers that can be used for the steering operation to relieve or manage the network congestion. This task is performed using data returned by the AFM model included the models 112.

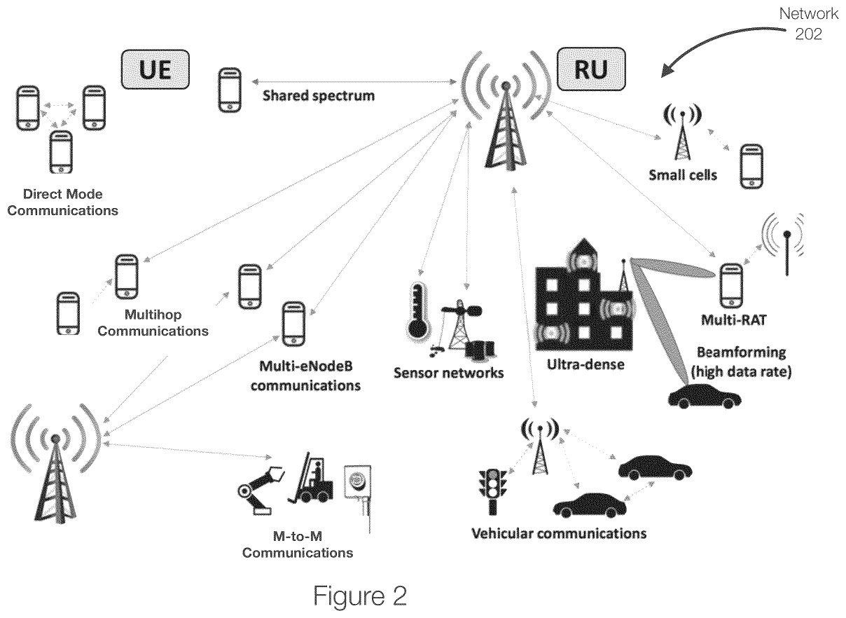

FIG. 2 discloses aspects of a network such as an O-RAN. FIG. 2 illustrates a network 202, which is an example of or which includes an example of the network 104. In this example, the network 202 includes towers, small cells, user equipment, multihop communications, multi-enodeB communications, sensor networks, vehicular communications, M-to-M communications, ultra-dense networks multi-RAT, beamforming, and the like. Each of these components may represent or include radio, distributed, and/or centralized units.

FIG. 2 illustrates the complexity of the network 202. Embodiments of the invention, which relate to network data management including data selection and data compression, allows the functions and operations of the network 202 to be performed based on data generated/provided/emulated/simulated by a digital twin.

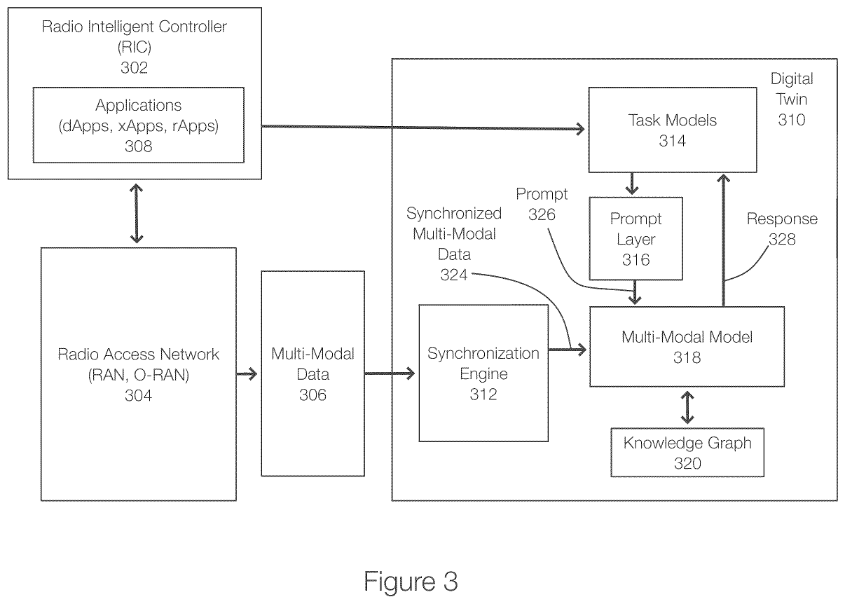

FIG. 3 discloses additional aspects of a digital twin configured to perform model-based data management. FIG. 3 illustrates an RIC 302 that includes or is associated with applications 308 (e.g., dApps, xApps, rApps). The applications 308 may be performed in or on the network 304.

In one example, multi-modal data 306 is captured, measured, and/or collected from the network 304 and input to the digital twin 310. As previously stated, the multi-modal data 306 may include, by way of example and not limitation, GPS data, RF data, camera data, LiDAR data, sensor data, or the like or combinations thereof.

In this example, the multi-modal data 306 is received and processed by a synchronization engine 312. The synchronization engine 312 is configured to align the data or identify data that occur within a specific time window, at a particular timestamp, or the like. This helps ensure that the data provided to the multi-modal model 318 is aligned or synchronized with respect to network operations and with respect to specific tasks. For example, RF data from two towers at the same timestamp may provide more insight compared to a situation where the RF data from the two towers corresponds to different points in time.

More specifically, multi-modal data 306 may provide additional input that improves the efficiency and output of the digital twin 310. For example, camera or LiDAR data may allow the multi-modal model 318 to recognize that there is an issue with hardware, such as damage. LiDAR data or camera data, which may represent damage to network equipment, may allow the multi-modal model 318 to generate a response that accounts for this damage. Thus, image data, sensor data (e.g., weather data, crowd size) may be accounted for and provide more insight. Plus, the interdependencies are accounted for in embodiments of the invention. In one example, inter-dependencies are difficult to identify in one mode of data (e.g., RF signals). The multi-modal model 318, which may be trained on multi-modal data, can account for inter-dependencies. For example, without the aid of multi-modal data, detecting a radio signal with insufficient signal strength a particular radio may result in a command to increase power at that radio. Multi-modal data, such as an image, may allow the reduced power to be attributed to damage or weather and may reduce the time to resolution or repair. Further, the multi-modal model 318 receives synchronized multi-modal data 324 from the synchronization engine 312.

The multi-modal model 318 is also associated with a knowledge base 320. In one example, telemetry 322 from the network 304, which may include aspects of the multi-modal data 306, may be received and included in or added to (e.g., an update) the knowledge graph 320. More specifically, the knowledge graph 320 may represent the network 304 (e.g., characteristics or attributes of hardware, applications, standard documents that include physical and logical dependencies among the network components, or the like) and may reflect an evolving representation of the network 304 based on updates. In one example, nodes of the knowledge graph 320 may represent radio components, user equipment, servers, or other components/applications/hardware in the network 304. The properties or edges of the nodes may represent metadata or other information. For example, a radio unit may correspond to a node of the knowledge graph 320 and be associated with properties such as recommended power consumption, recommended received signal strength, recommended transmitted signal power, or the like. In another example, a node may represent a user equipment and be associated with similar device properties, capabilities, recommended settings, or the like. A node may represent a distributed unit and be associated with similar properties. One benefit of the knowledge graph 320 is that the multi-modal model 318 is able to better recognize when a component is operating in a non-normal manner. For example, a radio may be associated with a recommended maximum power and the multi-modal data may indicate that this power is being exceeded. This type of information can augment the multi-modal data when the multi-modal model is generating the response 328.

Thus, the knowledge graph 320 represents, by way of example, knowledge, metadata, or characteristics the network 304 and is regularly or continually updated to account for changes that occur in the network 304 (e.g., new equipment, changed settings, physical and logical downstream dependencies among network components). In other words, the knowledge graph 320 represents the components or units in the network 304 and the associated values or properties. The data stored or represented in the knowledge graph 320 is used by model 318 in conjunction with the synchronized multi-modal data 324 (e.g., telemetry data) output by the synchronization engine 312. This knowledge graph 320, along with the synchronized multi-modal data, can inform at least the operation of selecting data for network management operations or for execution of the applications 308.

In this example, the applications 308 may perform operations in or related to the network 304 and may use or interact with task models 314 to perform the operations or functions. The task models 314 may also be LLMs or AFMs in some examples. This may allow communications to be performed semantically. For example, an application may send a request or prompt to a task model. The task model may be configured for the specific task or operation and may require certain information. In other words, the digital twin 310 may include or be associated with multiple task models, each of which may be configured for a specific task.

In one example, a task model that receives a request from an application may use a prompt layer 316 to generate a prompt 326 that is provided to the multi-modal model 318. The prompt 326 generated in response to the request received by the task model may include context that is provided by the first application or from another source (e.g., a retrieval augmented generation (RAG) type source). For example, the prompt 326 may be built using device/component specifications, logs, or the like. The prompt 326 is generated and input to the multi-modal model 318.

The multi-modal model 318 receives the prompt 326 and generates a response 328 that is based on the synchronized multi-modal data 324 and/or information retrieved from the knowledge graph 320. In one example, the knowledge graph 320 may be adapted to include telemetry data from the network.

In this example, the multi-modal model 318 may be trained using historical data associated with tasks performed by the applications 308, historical telemetry or multi-modal data of the network, or the like. For example, an xApp may generate a request to identify recommendations for routing traffic in order to balance network load and/or relieve network congestion.

The task model that receives this request may be specifically configured to recommend routes and may be trained on data relevant to routing communications of data in the network 304. The request from the xApp may include metadata such as location of the congestion or excessive network load, number of connected users, or the like.

The task model may generate a prompt for data related to routing or relevant to the inputs of the task model. This may include towers in the area experiencing the load, users connected to each of the towers, current signal strengths, power levels, or the like.

The multi-modal model 318, in response to the request, selects specific multi-modal data from either the most recent (and synchronized multi-modal data) and/or a relevant history of the multi-modal data (e.g., data in a specified time window). As discussed herein, the multi-modal model 318 may select data having different modalities. Thus, the selected data may include RF data, image data, sensor data, or the like. Once the data is selected, the multi-modal model 318 may clean and/or compress the selected multi-modal data. The response 328 thus includes multi-modal data that has been selected, cleaned, and/or compressed in response to the request. This helps ensure that the data included in the response 328 to the relevant task model can be used, in one example, after decompression. The task model is advantageously not required to process network data that may not be useful. In addition, the data included in the response 328 advantageously accounts for interdependencies of the network 304.

Further, because the multi-modal model 318 also has access to the knowledge graph 320, the response 328 also accounts for known or standardized component/application configurations, protocols, relationships, and the like.

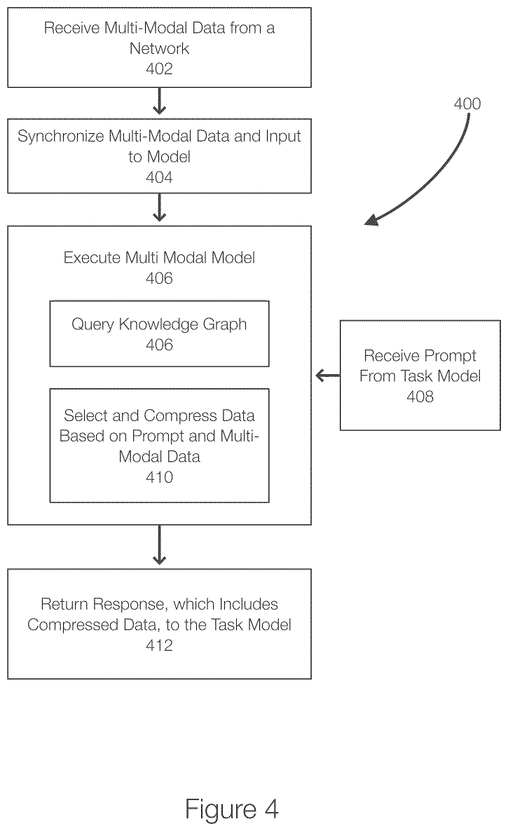

FIG. 4 discloses aspects of a method for performing data management in a network, such as an O-RAN network, which may include data selection data cleaning, and/or data compression. The method 400 may include receiving 402 multi-modal data from a network or portions thereof. The multi-modal data may be synchronized 404 and delivered to a model (e.g., the model 318). The model also receives 408 a prompt from a task model. In response to the prompt from the task model, the multi-modal model executes. This may include querying 406 a knowledge graph. Based on the multi-modal data (e.g., most recent multi-modal data) and information retrieved from the knowledge graph, the model may select, clean, and/or compress data to include in a response. The data that has been selected, cleaned, and/or compressed by the model is returned 412 to the task model in a response. Using the response, the task model performs its task and provides a response to the requesting application.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, data selection, data compression, data cleaning, multi-modal selection, cleaning, and/or compression operations, RIC operations, network management or network data management operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. Further, the AFMs may be trained with historical and/or synthetic data.

It is noted that any operations of any of the methods disclosed herein, may be performed in response to, as a result of, and/or, based upon, the performance of any preceding operations. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for managing data associated with a network with a digital twin that includes a multi-modal model, the method comprising: receiving multi-modal data from a network at the digital twin, receiving a prompt from a task model, selecting first multi-modal data from the multi-modal data received from the network by the multi-modal model based on the prompt received from the task model, compressing the first multi-modal data by the multi-modal model, generating a response by the multi-modal model that includes the compressed first multi-modal data, and returning the response to the task model in response to the prompt, wherein the task model performs an action based on the compressed first multi-modal data.

Embodiment 2. The method of embodiment 1, wherein the multi-modal model is a large language model or an agentic foundation model, further comprising synchronizing the multi-modal data received from the network such that an input to the multi-modal model includes the synchronized multi-modal data and such that the first multi-modal data is selected from the synchronized multi-modal data.

Embodiment 3. The method of embodiment 1 and/or 2, further comprising receiving, by the task model, a request from an application associated with a radio intelligent controller of the network.

Embodiment 4. The method of embodiment 1, 2, and/or 3, further comprising querying a knowledge graph, by the multi-modal model, of the network.

Embodiment 5. The method of embodiment 1, 2, 3, and/or 4, wherein the multi-modal data is further selected based on information retrieved from the knowledge graph.

Embodiment 6. The method of embodiment 1, 2, 3, 4, and/or 5, wherein the multi-modal data includes radio frequency (RF) data, camera data, LiDAR (Light Detection and Ranging) data, sensor data, or combinations thereof.

Embodiment 7. The method of embodiment 1, 2, 3, 4, 5, and/or 6, wherein the multi-modal model is trained using historical multi-modal data associated with the network such that the multi-modal model is trained to capture inter-dependencies among the components, applications, and/or hardware of the network, wherein the first multi-modal data selected by the multi-modal model accounts for inter-dependencies.

Embodiment 8. The method of embodiment 1, 2, 3, 4, 5, 6, and/or 7, further comprising cleaning the selected first multi-modal data.

Embodiment 9. The method of embodiment 1, 2, 3, 4, 5, 6, 7, and/or 8, wherein the network is a radio access network, an open radio access network, and/or a telecommunications network.

Embodiment 10. The method of embodiment 1, 2, 3, 4, 5, 6, 7, 8, and/or 9, wherein the prompt is based on the request and/or sources relevant to the network including specifications, protocols, and/or logs.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any parts of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

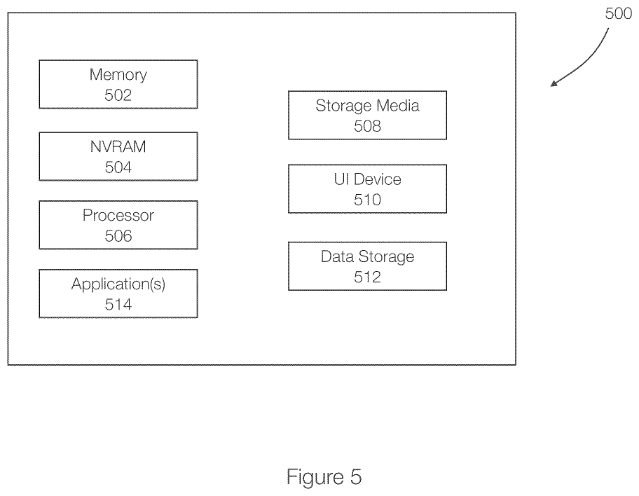

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual, containerized, or physical. The device 500 may perform or execute steps or acts of the methods illustrated in the Figures.

The device 500 may represent a cloud-based system, an edge-based, system, an on-premise system, or combinations thereof. Document understanding and related operations may be performed using these types of computing environments/systems.

In one example, the RIC and/or digital twin may be integrated with the network, may be implemented using servers, clusters, or the like. The RIC and/or digital twin may include distributed components or be implemented in a distributed manner. Data input to the models may be sourced from multiple locations and multiple models may be used in parallel.

The described embodiments are to be considered in all respects only as illustrative and not restrictive. All changes which come within the meaning and range of equivalency of the claims are to be embraced within their scope.

What is claimed is:

1. A method for managing data associated with a network with a digital twin that includes a multi-modal model, the method comprising:
receiving multi-modal data from a network at the digital twin;
receiving a prompt from a task model;
selecting first multi-modal data from the multi-modal data received from the network by the multi-modal model based on the prompt received from the task model;
compressing the first multi-modal data by the multi-modal model;
generating a response by the multi-modal model that includes the compressed first multi-modal data; and
returning the response to the task model in response to the prompt, wherein the task model performs an action based on the compressed first multi-modal data.

2. The method of claim 1, wherein the multi-modal model is a large language model or an agentic foundation model, further comprising synchronizing the multi-modal data received from the network such that an input to the multi-modal model includes the synchronized multi-modal data and such that the first multi-modal data is selected from the synchronized multi-modal data.

3. The method of claim 2, further comprising receiving, by the task model, a request from an application associated with a radio intelligent controller of the network.

4. The method of claim 2, further comprising querying a knowledge graph, by the multi-modal model, of the network.

5. The method of claim 4, wherein the multi-modal data is further selected based on information retrieved from the knowledge graph.

6. The method of claim 4, wherein the multi-modal data includes radio frequency (RF) data, camera data, LiDAR (Light Detection and Ranging) data, sensor data, or combinations thereof.

7. The method of claim 6, wherein the multi-modal model is trained using historical multi-modal data associated with the network such that the multi-modal model is trained to capture inter-dependencies among the components, applications, and/or hardware of the network, wherein the first multi-modal data selected by the multi-modal model accounts for inter-dependencies.

8. The method of claim 1, further comprising cleaning the selected first multi-modal data.

9. The method of claim 1, wherein the network is a radio access network, an open radio access network, and/or a telecommunications network.

10. The method of claim 1, wherein the prompt is based on the request and/or sources relevant to the network including specifications, protocols, and/or logs.

11. A non-transitory storage medium having stored therein instructions that are executable by one or more hardware processors to perform operations for managing data associated with a network with a digital twin that includes a multi-modal model, the operations comprising:
receiving multi-modal data from a network at the digital twin;
receiving a prompt from a task model;
selecting first multi-modal data from the multi-modal data received from the network by the multi-modal model based on the prompt received from the task model;
compressing the first multi-modal data by the multi-modal model;
generating a response by the multi-modal model that includes the compressed first multi-modal data; and
returning the response to the task model in response to the prompt, wherein the task model performs an action based on the compressed first multi-modal data.

12. The non-transitory storage medium of claim 11, wherein the multi-modal model is a large language model or an agentic foundation model, further comprising synchronizing the multi-modal data received from the network such that an input to the multi-modal model includes the synchronized multi-modal data and such that the first multi-modal data is selected from the synchronized multi-modal data.

13. The non-transitory storage medium of claim 12, further comprising receiving, by the task model, a request from an application associated with a radio intelligent controller of the network.

14. The non-transitory storage medium of claim 12, further comprising querying a knowledge graph, by the multi-modal model, of the network.

15. The non-transitory storage medium of claim 14, wherein the multi-modal data is further selected based on information retrieved from the knowledge graph.

16. The non-transitory storage medium of claim 14, wherein the multi-modal data includes radio frequency (RF) data, camera data, LiDAR (Light Detection and Ranging) data, sensor data, or combinations thereof.

17. The non-transitory storage medium of claim 16, wherein the multi-modal model is trained using historical multi-modal data associated with the network such that the multi-modal model is trained to capture inter-dependencies among the components, applications, and/or hardware of the network, wherein the first multi-modal data selected by the multi-modal model accounts for inter-dependencies.

18. The non-transitory storage medium of claim 11, further comprising cleaning the selected first multi-modal data.

19. The non-transitory storage medium of claim 11, wherein the network is a radio access network, an open radio access network, and/or a telecommunications network.

20. The non-transitory storage medium of claim 11, wherein the prompt is based on the request and/or sources relevant to the network including specifications, protocols, and/or logs.
